(19) United States
(12) Patent Application Publication
(10) Pub. No.: US 2009/0231764 A1
(43) Pub. Date: Sep. 17, 2009

(54) Capacitor Bank Monitor and Method of use Thereof

(75) Inventors: John Fredrick Banting, Waukesha, WI (US); Anand Sharad Kulkarni, Jackson, WI (US)

Correspondence Address: KING & SPALDING, 1180 PEACHTREE STREET , NE, ATLANTA, GA, 30309-3521, US

(73) Assignee: Cooper Technologies Company, Houston, TX (US)

(21) Appl. No.: 12/048,963

(22) Filed: Mar. 14, 2008

(51) Int. Cl. H01G 2/16; G08B 21/00

(52) U.S. Cl. 361/15; 340/638

(57) ABSTRACT

A capacitor bank monitor apparatus for monitoring a state of a common ground connected to a capacitor bank comprises a sensor that that can be coupled to the common ground for collecting measurements relating to the state of the common ground. The monitor also comprises a controller that is logically coupled to the sensor for receiving the measurements and determining whether a fuse on the capacitor bank has opened. The ground monitor also comprises a communications facility that is logically coupled to the controller for communicating a notification that the fuse has opened. The communications facility may comprise a cellular communications device. The ground monitor also may comprise a filter that is electrically connected to the sensor and the controller. The ground monitor also may comprise memory that is logically coupled to the controller for storing at least one state of the common ground.

### RELATED APPLICATIONS

This application is related to U.S. patent application Ser. No. 11/982,587, entitled “Faulted Circuit Indicator Apparatus with Transmission Line State Display and Method of Use Thereof,” filed on Nov. 2, 2007 and U.S. patent application Ser. No. 11/982,588, entitled “Communicating Faulted Circuit Indicator Apparatus and Method of Use Thereof,” filed on Nov. 2, 2007. The complete disclosure of each of the above-identified related applications is hereby fully incorporated herein by reference.

### TECHNICAL FIELD

The invention relates generally to capacitor banks for electrical power distribution systems, and more particularly to a system and method for the convenient monitoring of capacitor banks.

### BACKGROUND

Capacitor banks are used throughout the electric power distribution industry. Typically, capacitor banks act to maintain a relatively constant power factor over a portion of an electric transmission or distribution system during periods of heavy loads. For example, in a distribution system that feeds a residential area, loads may increase unexpectedly due to a sudden increase in air conditioner use in hot weather. Capacitor banks assist in correcting the power factor of the system and maintaining the system voltage during load variations. Capacitor banks are used both in distribution systems and transmission systems—in any location where an increase or decrease in electrical load may occur.

In a typical capacitor bank installation, at least one capacitor is connected between each phase of a three phase conductor and ground. A typical installation may include multiple capacitors for each phase. Because the capacitors are connected to ground, if a capacitor should fail, the result can be a short circuit to ground. Such a short circuit would be highly detrimental to the operation of the distribution system. Accordingly, fuses are typically connected between each phase conductor and its respective capacitor(s) to minimize the negative effects of such a short circuit.

The fuses are designed to open or “blow”—if a short circuit should occur, which effectively removes the capacitor bank from the system for the phase connected to the opened fuse. The distribution system will still operate, but the disconnected phase will lose the benefit of the disconnected capacitor bank until the fuse is replaced. Events other than a short circuit across failed capacitors also can result in opening the fuse. For example, a power surge can open a fuse, thereby removing a capacitor bank from the distribution system. Studies have determined that fuse operation on capacitor banks occur quite frequently, and in some cases affect approximately 30% of installed capacitor banks.

A significant problem with conventional capacitor bank solutions is that the only way to determine if a fuse has opened is to inspect each capacitor bank manually. This inspection can be an expensive proposition, and many electrical utility companies manage the expense by inspecting each capacitor bank only once per year. Accordingly, if a fuse should open shortly after an annual inspection, the capacitor bank may be removed from the system for nearly a year without the knowledge of the utility company. In the meantime, the company may note that its distribution system is not maintaining a proper power factor in the area served by the disconnected capacitor bank and may unnecessarily purchase and install additional capacitor banks to help maintain the power factor.

An additional problem with the conventional system is that a way to establish whether individual capacitors have failed without manually testing each capacitor does not exist. Typically, in an implementation where multiple capacitors are installed on each phase, the capacitors do not all fail simultaneously. Rather, a single capacitor will fail, and the increased load across the remaining capacitors will cause them to fail at a later time. Without a way—short of a manual inspection—to determine whether a single capacitor has failed, only regular maintenance or a total failure will indicate to the utility company whether remedial action needs to be taken to protect the remaining capacitors.

Accordingly, there is a need to overcome the limitations of the prior art by developing a capacitor bank monitor that is capable of determining whether a fuse has opened and providing notice to the utility company of the event. Additionally, there is a need in the art for the monitor to provide additional monitoring to determine whether conditions that may be indicative of an impending failure exist and for the monitor to notify the utility company of the existence of those conditions.

### SUMMARY

The invention can satisfy the above-described needs by providing a capacitor bank ground monitor that has a communications facility for communicating notice that a fuse in the capacitor bank has opened. The ground monitor includes a sensor that collects measurements relating to at least one state of the common ground of the capacitor hank. The sensor is coupled to a controller that receives the measurements and determines whether a fuse has opened in the capacitor bank. The controller is further coupled to a communications facility that can communicate notice that a fuse has opened.

The ground monitor may further include a filter that passes current measurements only at certain frequencies. The ground monitor may also include a memory for storing at least one state of the common ground. The communications facility may transmit the stored states, as well as the notice of the fuse opening. The communications facility may be a cellular communications device and may ultimately communicate the notification to at least one of a telephone number, an internet address, or an email address.

Additional aspects, features, and advantages of the invention will become apparent to those having ordinary skill in the art upon consideration of the following detailed description of illustrated embodiments exemplifying the best mode of carrying out the invention as presently perceived.

### BRIEF DESCRIPTION OF THE DRAWINGS

FIG. 1A is a block diagram depicting a capacitor bank connected to an electric power distribution system.

FIG. 1B is a block diagram of a capacitor bank including a neutral monitor according to an exemplary embodiment of the invention.

FIG. 2 is a block diagram of a capacitor bank neutral monitor according to an exemplary embodiment of the invention.

FIG. 3 is a flow chart of a method for monitoring the status of a capacitor bank with a neutral monitor according to an exemplary embodiment of the invention.

### DETAILED DESCRIPTION OF EXEMPLARY EMBODIMENTS

The invention provides a capacitor bank neutral monitor system capable of determining whether one or more of the fuses connecting the capacitor bank to the electric power distribution system has opened and communicating that fact to the electrical utility. The capacitor bank neutral monitor is coupled to the common ground inside a capacitor bank and monitors for conditions on the common ground that indicate a fuse opening.

The capacitor bank neutral monitor also can provide additional monitoring capabilities related to the operation of the capacitor bank and the monitor itself. Finally, the capacitor bank neutral monitor can be reprogrammed from a remote location, which allows for the dynamic modification of monitoring operations that can change based on the needs of the utility company.

As used herein, the term “transmission line” or “line” is intended to encompass any type of conductor that is used to transmit electricity from one location to another, but particularly refers to utility cables, whether above ground, underground, or otherwise, that are commonly used in electricity distribution systems. The terms “common ground,” “ground,” or “ground wire” refer generally to the common ground wire in a typical capacitor bank for three-phase electric power distribution. The term “distribution system” refers to an electrical distribution system wherein electricity generated at one or more electricity generation sites, or power plants, is transported and distributed to electricity consumers. The terms “technician” or “line technician” are interchangeably used to describe individuals whose responsibilities generally include maintaining the distribution system and capacitor banks on the system. The term “utility company” refers generally to an individual, entity, or group of individuals or entities responsible for maintaining at least a portion of a power distribution system that includes capacitor banks. The terms “open,” “blow,” “trip,” “opened,” “tripped,” or “blown” refer to the state of a fuse such that current no longer flows across the fuse. The terms “close,” “closed,” “replace,” or “replaced” refer to the act or state of causing a fuse to allow current flow to resume.

Referring now to the attached figures, in which like numerals represent like elements, certain exemplary embodiments of the invention will hereafter be described.

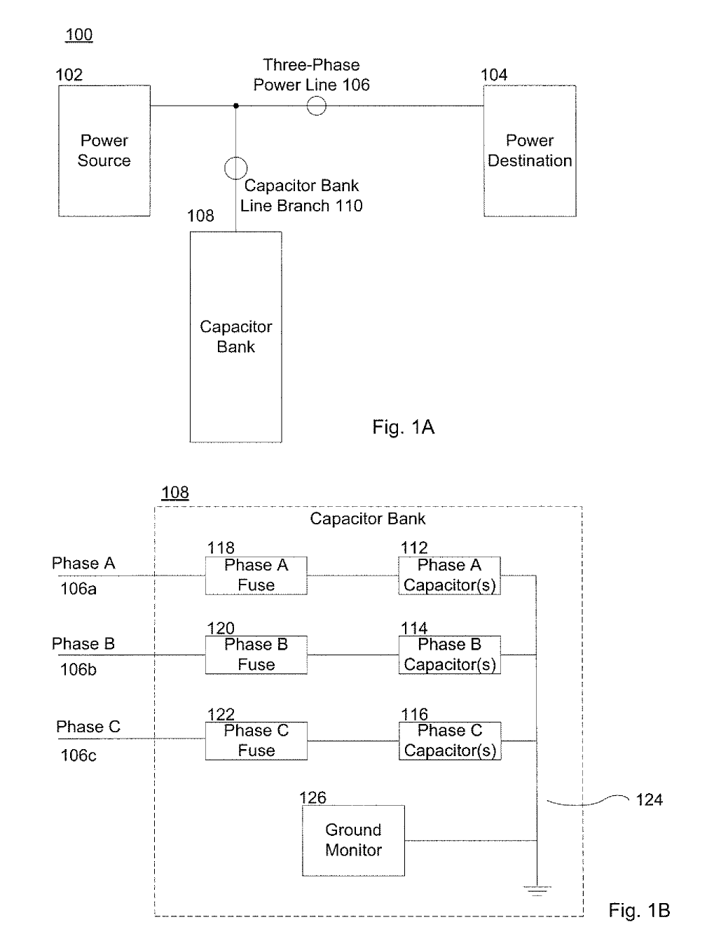

FIG. 1A is a block diagram of a capacitor bank installation in an electrical distribution or transmission system 100. As illustrated in FIG. 1, a power source 102 provides electricity to a power destination 104, such as an end user, via a three-phase power line 106. A capacitor bank 108 is incorporated into the system 100 by connecting a branch 110 of the transmission line—including the phase wires for each of the three phases (106a, 106b, 106c (FIG. 1B)) to the capacitor bank 108.

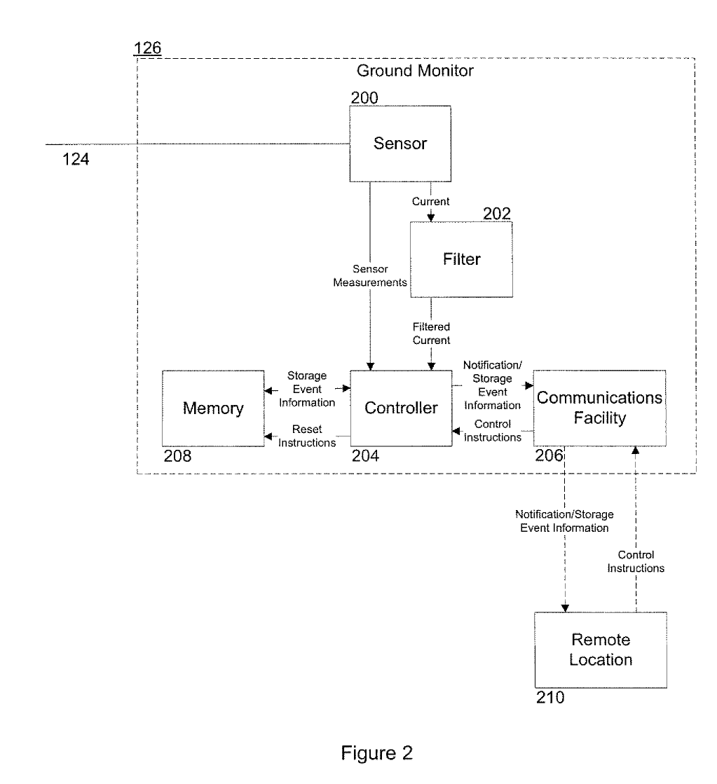

FIG. 1B is a block diagram depicting a capacitor bank 108 electrically coupled to the three-phase power line 106 and including a ground monitor 126 according to an exemplary embodiment. As shown in FIG. 1B, phase A, B, and C capacitor(s) 112, 114, 116 of the capacitor bank 108 are electrically connected to each incoming phase wire 106a, 106b, 106c, respectively, via corresponding fuses 118, 120, 122. The fuses 118, 120, 122 are designed to open in the event that a current through the fuse 118, 120, 122 exceeds a predetermined threshold. Each capacitor 112, 114, 116 is then connected to a common ground 124. The ground monitor device 126 is coupled to the common ground 124. The connection between the ground monitor 126 and the common ground 124 is established via a clamping mechanism that provides physical connectivity to the common ground 124, and also provides the coupled connection to the sensor of the to the ground monitor 126, which will be discussed in further detail with respect to FIG. 2.

FIG. 2 is a block diagram depicting a capacitor bank ground monitor 126 according to an exemplary embodiment. As shown in FIG. 2, the ground monitor 126 includes a sensor 200 that is coupled to the common ground 124 of a capacitor bank 108. In an exemplary embodiment, the sensor 200 measures current passing through the common ground 124.

In an exemplary embodiment, the sensor 200 then transmits the current measurements to a filter 202. The filter 202 is a dynamic filter capable of filtering out measurements of current that are not of one or more predetermined frequencies. Under normal operating conditions, current is generated on the common ground 124 in a variety of frequencies. However, in this embodiment, only current at the operating frequency of the three-phase power line 106, such as 60 Hz, and its harmonics is pertinent to determining whether a fuse 118, 120, 122 in the capacitor bank 108 has opened. Accordingly, the exemplary filter 202 passes only measurements of the operating frequency (such as 60 Hz) current and its harmonics to a controller 204. In an alternative exemplary embodiment, the filter 202 can be set up to pass any frequency determined to be of interest to the utility.

In an alternative embodiment, the sensor 200 may detect other conditions that may be present on the common ground 124 or within the capacitor bank 108. For example, the sensor 200 may detect a temperature in the capacitor bank 108 or a temperature on the common ground 124. The sensor 200 also may be connected to individual groups of capacitors 112, 114, 116 to determine a temperature of each individual group. In that way, the ground monitor 126 may determine whether individual capacitors 112, 114, 116 have failed before all of the capacitors 112, 114, 116 in the bank fail. Many of these alternative measurements need not be filtered before they are passed to the controller 204, and therefore may be transmitted directly from the sensor 200 to the controller 204.

Once the measurements from the sensor 200 have been appropriately filtered, if necessary, they are transmitted to the controller 204. The controller 204 analyzes the measurements and takes appropriate actions. In an exemplary embodiment, the controller 204 comprises a microcontroller programmed to analyze the measurements and to respond appropriately. In an alternative embodiment, the controller 204 may be any suitable control mechanism capable of receiving measurements from the sensor 200 and controlling peripheral systems, such as memory 208 and a communications facility 206. For example, the controller 204 can comprise any combination of analog and/or digital electronics capable of establishing that a measured current value increases at a rate of change that exceeds a certain threshold or that another measured value exceeds a certain threshold.

In one exemplary embodiment, the controller 204 is programmed to recognize certain changes in the measurements from the sensor 200 as notification events. A notification event is an occurrence that indicates a fuse 118, 120, 122 opening or other event that results in disconnecting the capacitor bank 108 from the transmission system 100. For example, when a fuse 118, 120, 122 on a capacitor bank 108 opens, current at the operating frequency is generated on the common ground 124. Accordingly, the controller 204 may be programmed to treat an increase in the amplitude of current at the operating frequency that exceeds a certain threshold rate of change as indicating a fuse 118, 120, 122 opening and therefore as a notification event. In an exemplary embodiment, a change in the amplitude of current exceeding ten percent indicates the opening of a fuse 118, 120, 122. In an alternative embodiment, the thresholds may vary from location to location or from one electrical power distribution system to another based on operational characteristics unique to a particular utility.

In an alternative embodiment, the controller 204 can be programmed to identify any condition that occurs on the common ground 124 or in the capacitor bank 108 as a notification event. For example, the controller 204 can be programmed to identify current having amplitude in excess of a certain threshold, a temperature reading in excess of a predetermined threshold, or vibration in excess of a predefined threshold as a notification event, as these events may indicate a potential problem on the capacitor bank 108. For example, unusual temperatures on the capacitor bank 108 may indicate that the capacitor bank is not operating efficiently. Excessive vibration may indicate damage to the support structure for the capacitor bank 108. These and other failure-indicative conditions are well known to those having ordinary skill in the relevant art. The thresholds may be defined by the utility company employing the ground monitor 126 in an electrical distribution or transmission system, and can vary based on conditions in a particular application. If the controller 204 determines that a notification event has occurred, it can communicate that fact to one or both of the ground monitor's memory 208 or communications facility 206.

Once the controller 204 determines that a notification event has occurred, the controller 204, based on its programming, determines the information to transmit via the communications facility 206. In an exemplary embodiment, if the controller 204 determines that a particular current measurement is indicative of a fuse 118, 120, 122 opening, and is therefore a notification event, the controller 204 may determine that one or more of the sensor measurements, the time the measurements were made, and the global coordinates (or other identifying characteristic) of the ground monitor 126 should be transmitted. Having thus established the existence of a notification event and the information that should be transmitted with that event, the controller 204 then passes the information to a communications facility 206, which will be discussed in further detail below.

In an alternative embodiment, the controller 204 may treat information other than sensor 200 measurements as notification events. For example, the controller 204 may be programmed to treat the passage of a certain period of time as a notification event. According to this embodiment, the controller 204 can be programmed to transmit the sensor measurements at programmed intervals, such as once an hour, once a day, or any other suitable time period the utility company or other recipient of the information deems appropriate. In this embodiment, the controller 204 also may be programmed to transmit event information that is stored in a memory 208 in addition to, or in lieu of, the present state of the common ground 124. By way of example only, the controller 204 can record a sensor measurement once per hour for twenty-four hours and then transmit the collected sensor data via the communications facility 206 at the end of the twenty-four hour period. Additionally, the controller 204 may determine that information relating to the ground monitor 126 itself, such as low battery power, constitutes a notification event, which may then be transmitted.

The controller 204 may be further programmed to identify storage events that may be valuable to a utility company in diagnosing problems or inefficiencies in a particular capacitor bank 108 or in the distribution system 100 itself, but are not sufficiently important to require immediate attention. The controller 204 may be configured to record storage events and related information in the memory 208 for later analysis by the utility company, a line technician, or another interested party. Additionally, the controller 204 may be configured such that any event determined to be a notification event is also treated as a storage event, and therefore the ground monitor 126 will provide utilities the option of storing the existence of notification events and related information for later retrieval and analysis.

By way of example, an increase in temperature on a common ground 124 may not be indicative of a fuse 118, 120, 122 opening, and therefore is not an event that requires immediate attention, but may indicate that the common ground 124, or some of its nearby equipment, has developed a flaw that may ultimately result in a failure. Accordingly, the controller 204 may be programmed to identify the temperature increase as a storage event and to store data related to the increase in the memory 208. Because the controller 204 has identified the condition before a failure occurs, the utility company can determine whether remedial action is necessary to improve the performance of the transmission or distribution system 100 or to prevent a failure that may later result in reduced quality of service to the utility company's customers. The storage event information may be transmitted to the utility company on a periodic basis, or at the request of the utility company.

As described above, if the controller 204 determines that a notification event has occurred, then the controller 204 may communicate that fact, and any related information, to the communications facility 206 for transmission to a remote location 210, which, in one embodiment, is a utility company. The communications facility 206 is a system that is capable of transmitting data to, and receiving data from, the remote location 210. In one embodiment, the communications facility 206 employs a wireless communications protocol for transmitting and receiving information. For example, the communications facility 206 may use a cellular communications device, capable of transmitting using cellular communications protocols such as GSM/GPRS or CDMA. The communications facility 206 also may use short range wireless protocols such as Bluetooth (IEEE 802.15.1) or ZigBee (IEEE 802.15.4), wireless internet (WiFi) protocols such as 802.11A, b, or g, or any other radio frequency (RF) or infrared (IR) communications protocol. In an alternative embodiment, the communications facility 206 may use wired communications protocols, such as power line networking to transmit and receive information.

The communications facility 206 may use a variety of methods to transmit information. In an exemplary embodiment, the communications facility 206 will open an internet protocol (IP) connection to a server associated with the utility company. The server may then process the information for the utility. By way of example, if the ground monitor 126 determines that a fuse 118, 120, 122 has opened on a capacitor bank 108 and transmits that information to a utility company server, there are a number of potential steps the server may take. For example, the server may transmit the information to a graphical display system that will communicate the occurrence of the transmitted event to utility company operators who may then determine how best to handle the event. The server may also respond by directly notifying repair technicians in the area of the ground monitor 126 that reported the event that a fuse 118, 120, 122 on a capacitor bank 108 has opened.

The communications facility 206 also can transmit information directly to key individuals. For example, the telephone numbers of one or more individuals responsible for the maintenance of a particular capacitor bank 108 may be programmed into the communications facility 206 or stored in the memory 208. The communications facility 206 may then directly notify those individuals by placing a telephone call, or, in one embodiment, by sending a text message, such as an electronic mail message (e-mail), or short message service (SMS) message to the relevant individuals.

Furthermore, the method of communication used to transmit the information may vary based on the type of event. For example, critical events—such as those that are indicative of a capacitor bank use 118, 120, 122 opening—may be transmitted as text messages directly to individuals that are responsible for maintaining the capacitor bank 108, and may be simultaneously transmitted to the utility company's central server. However, for less critical events, such as the periodic transmission of the state of the common ground 124, the information may be sent only to the central server which may be programmed to store and analyze the information or simply to ignore it.

In one embodiment, the ground monitor 126 also may receive control instructions from the remote location 210 via the communications facility 206. The control instructions may relate to updated programming for the controller 204, including modifications to the conditions that give rise to a notification event or a storage event, as well as updates to the information that should be transmitted or stored in relation to those events. The control instructions also may comprise reset instructions that direct the controller 204 to reset the memory 208.

Additionally, a utility company may demand information directly from the ground monitor 126. In an exemplary embodiment, this demand can be accomplished by instructing the controller 204 (via the communications facility 206) to transmit information to the utility company. In this embodiment, the utility company may demand the present measurements of the sensor 200, or any storage event information stored in the memory 208. In response to these instructions, the controller 204 can retrieve the requested information from the memory 208, the sensor 200, or both, and can provide the information to the communications facility 206 for transmission back to the utility company.

The memory 208 can be any suitable storage device, such as flash memory or dynamic random access memory (DRAM). In an exemplary embodiment, the controller 204 determines whether a storage event has occurred and stores information relevant to the event in the memory 208. The controller 204 can then request stored information from the memory 208 in response to a notification event or an information demand from the utility company and can communicate that information to the communications facility 206 for transmission to the remote location 210. The memory 208 also may receive reset instructions from the controller 204, which, when received, results in clearing at least a portion of the memory 208.

Additionally, the memory 208 may store information relating to the ground monitor 126 itself. This information can be any information that will assist the utility company's determination of which capacitor bank 108 the transmitted information relates to, and may include the geographic coordinates of the ground monitor 126, a unique identifier for that ground monitor 126 that can be resolved to its installation location, the actual installation location of the ground monitor 126 (for example, the street address of a substation where the monitor is installed), or any other information that could provide the location of the ground monitor 126 or the capacitor bank 108 in which it is installed. For example, upon installation, the latitude and longitude of the site of the ground monitor 126 installation may be stored in the memory 208. Accordingly, when the ground monitor 126 transmits information, the transmission may include the latitude and longitude of the monitor (or an indicator thereof), which will assist the utility company in determining exactly which ground monitor 126 has transmitted information. The storage of information relating to the ground monitor 126 may require special processing when resetting the memory 208, as identifying information generally should not be cleared upon a reset event.

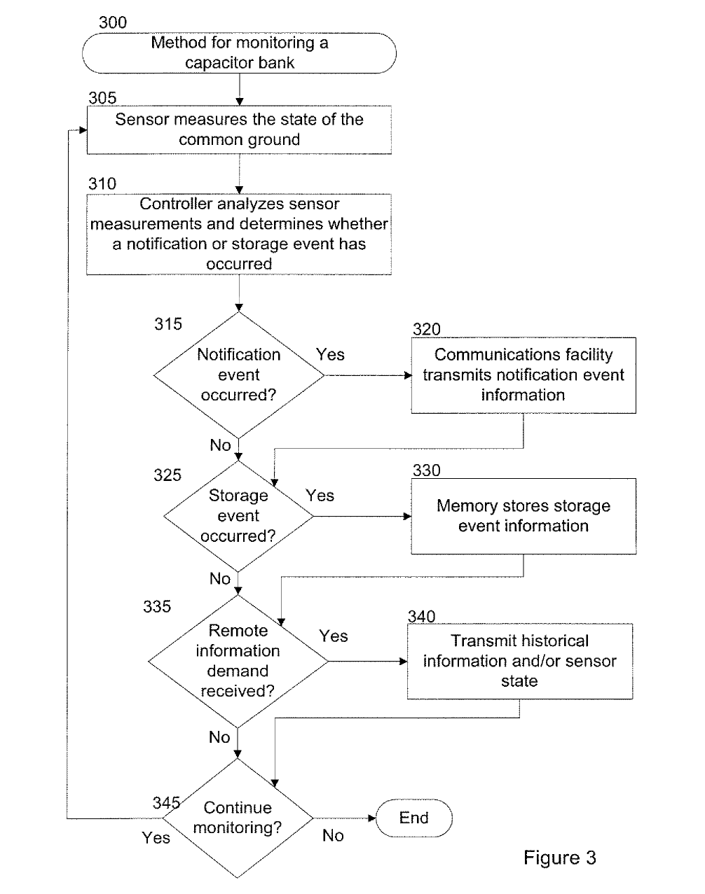

FIG. 3 is a flow chart illustrated a method 300 for monitoring a status of a capacitor bank 108 with a ground monitor 126 according to an exemplary embodiment. The method 300 assumes that the ground monitor 126 has already been connected to the common ground 124 in a capacitor bank 108 and is in operation. FIG. 3 will be discussed with reference to FIGS. 1 and 2.

In step 305, the sensor 200 measures a state of the common ground 124 and transmits that measurement to the controller 204. As described above, if the sensor 200 is measuring the current on the common ground 124, the measurement may have to pass through a filter 202 before being transmitted to the controller 204. The method 300 then continues to step 310.

In step 310, the controller 204 analyzes the sensor 200 measurements to determine whether an event has occurred that requires notification, storage, or both. In step 315, if the controller 204 has determined that a notification event has not occurred, the method 300 branches to step 325. If a notification event has occurred, the method 300 branches to step 320, wherein the controller 204 directs the communications facility 206 to transmit information related to the notification event to the remote location 210. The method 300 then proceeds to step 325.

In step 325, the controller 204 determines whether a storage event has occurred. If a storage event has not occurred, the method 300 branches to step 335. If a storage event has occurred, the method 300 branches to step 330, wherein the controller 204 stores information related to the event in the memory 208. The method 300 then proceeds to step 335.

In step 335, the controller 204 determines whether it has received a demand for information. The demanded information may include the sensor 200 measurements at the time of the demand, any stored information, or both. If no such demand has been made, the method 300 branches to step 345. If a demand has been made, the method 300 branches to step 340, wherein the controller 204 responds to the demand. If the demand is for the present state, the controller 204 gathers the measurements from the sensor 200 and transmits those measurements hack to the utility company. If the demand is for stored information, the controller 204 requests stored information from the memory 208 and transmits that information back to the utility company. The method 300 then proceeds to step 345.

In step 345, the controller 204 determines whether the ground monitor should continue to monitor the capacitor bank 108. If so, then the method 300 branches back to step 305 and continues to monitor the capacitor bank 108. Otherwise, the method 300 terminates.

Based on the foregoing, it can be seen that the invention provides a capacitor bank monitor apparatus having a communications facility that can notify a utility company of problems with the capacitor bank. The invention also provides a method for using a capacitor bank monitor to monitor a capacitor bank. Many other modifications, features, and embodiments of the invention will become evident to those of ordinary skill in the art. It should be appreciated, therefore, that many aspects of the invention were described above by way of example only and are not intended as required or essential elements of the invention unless explicitly stated otherwise. Accordingly, it should be understood that the foregoing relates only to certain embodiments of the invention and that numerous changes may be made therein without departing from the spirit and scope of the invention as defined by the following claims. It should also be understood that the invention is not restricted to the illustrated embodiments and that various modifications can be made within the scope of the following claims.

What is claimed is:

1. A monitor for a capacitor bank, wherein the capacitor bank comprises a power line, the power line being electrically connected to a fuse and at least one capacitor of the capacitor bank, wherein the at least one capacitor is coupled to a common ground, comprising:
a sensor that can be coupled to the common ground and that is configured to collect measurements relating to at least one state of the common ground; and
a controller logically coupled to the sensor and configured to receive the measurements from the sensor and to determine whether the fuse has opened based on the measurements.

2. The monitor of claim 1, further comprising a filter configured to identify particular measurements from the sensor and to pass the particular measurements to the controller.

3. The monitor of claim 1, further comprising a memory logically coupled to the controller and configured to store the measurements.

4. The monitor of claim 1, further comprising a communications facility logically coupled to the controller and configured to communicate a notification that the fuse has opened.

5. The monitor of claim 4, further comprising a memory logically coupled to the controller and configured to store the measurements, wherein the communications facility is further logically coupled to the memory to receive the at least one state of the common ground and to communicate the at least one state of the common ground.

6. The monitor of claim 4, wherein the communications facility comprises a cellular communications device.

7. The monitor of claim 4, wherein the communications facility communicates the notification to at least one of a telephone number, an internet address, and an email address.

8. The monitor of claim 1, wherein the at least one state of the neutral line comprises an amplitude of an operating frequency of current of the capacitor bank.

9. A capacitor bank, comprising:
a branch line comprising a power line;
a fuse electrically connected to the power line;
at least one capacitor electrically connected to the fuse;
a common ground electrically connected to the at least one capacitor;
a sensor coupled to the common ground and configured to collect measurements relating to at least one state of the common ground; and
a controller logically coupled to the sensor and configured to receive the measurements and to determine whether the fuse has opened based on the measurements.

10. The capacitor bank of claim 9, further comprising a filter configured to identify particular measurements from the sensor and to pass the particular measurements to the controller.

11. The capacitor bank of claim 9, further comprising a memory logically coupled to the controller and configured to store the measurements.

12. The capacitor bank of claim 9, further comprising a communications facility logically coupled to the controller and configured to communicate a notification that the fuse has opened.

13. The capacitor bank of claim 12, further comprising a memory logically coupled to the controller and configured to store the measurements, wherein the communications facility is further logically coupled to the memory to receive the at least one state of the common ground and to communicate the at least one state of the common ground.

14. The capacitor bank of claim 12, wherein the communications facility comprises a cellular communications device.

15. The capacitor bank of claim 12, wherein the communications facility communicates the notification to at least one of a telephone number, an internet address, and an email address.

16. The capacitor bank of claim 9, wherein the at least one state of the common ground comprises an amplitude of an operating frequency of current through the common ground.

17. A method for determining the state of a capacitor bank, comprising:
measuring at least one state of a common ground electrically coupled to the capacitor bank; and
determining whether a fuse electrically coupled to a power line and the capacitor bank has opened based on the at least one state of the common ground.

18. The method of claim 17, further comprising the steps of
determining whether the state of the common ground is indicative of a potential failure in the capacitor bank; and
communicating a notification of the potential failure.

19. The method of claim 18, further comprising storing the state in a memory.

20. The method of claim 17, further comprising the step of communicating a notification that the fuse has opened in response to determining that the fuse has opened.

21. The method of claim 17, wherein the communicating step comprises one of contacting a telephone number of an intended recipient of the notification, sending a text message to the intended recipient of the notification, and establishing an internet connection with the intended recipient of the notification.

22. The method of claim 17, wherein the state of the common ground comprises an amplitude of an operating frequency of current through the common ground.

23. The method of claim 17, further comprising the step of measuring at least one second state of the capacitor bank.

24. The method of claim 23, wherein the at least one second state is one of a temperature and a vibration of the capacitor bank.
